(19) United States
(12) Patent Application Publication
(10) Pub. No.: US 2026/0196624 A1
(43) Pub. Date: Jul. 9, 2026

(54) SECONDARY BATTERY

(71) Applicant: SAMSUNG SDI CO., LTD., Yongin-si (KR)

(72) Inventors: Dae Kyu KIM, Yongin-si (KR); Kwang Soo SEO, Yongin-si (KR)

(21) Appl. No.: 19/333,721

(22) Filed: Sep. 19, 2025

(30) Foreign Application Priority Data
Jan. 7, 2025 (KR) 10-2025-0002126

(51) Int. Cl. H01M 50/188; H01M 50/548; H01M 50/593

(52) U.S. Cl. CPC H01M 50/188; H01M 50/548; H01M 50/593

(57) ABSTRACT

The secondary battery according to the embodiment includes a can comprising a side surface and an upper surface, with an opening being formed in the can, and with a terminal hole being formed in the upper surface. An electrode assembly is accommodated in the can. A cap plate seals the opening. A first current collector plate is positioned between the electrode assembly and the upper surface. A second current collector plate is positioned between the electrode assembly and the cap plate. An insulator is positioned between the upper surface and the first current collector plate. A terminal part is inserted into a terminal hole of the upper surface. A fixing member is provided on the first current collector plate, with the fixing member comprising a first fixing part and a second fixing part penetrating the first fixing part.

### CROSS-REFERENCE TO THE RELATED APPLICATION

The present application claims priority to and the benefit of Korean Patent Application No. 10-2025-0002126, filed on Jan. 7, 2025, in the Korean Intellectual Property Office, the entire disclosure of which is incorporated herein by reference.

### BACKGROUND

### 1. Field

Embodiments relate to relates to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery.

The secondary battery according to an embodiment includes a can comprising a side surface and an upper surface, and with an opening being formed in the can, and with a terminal hole being formed in the upper surface; an electrode assembly accommodated in the can; a cap plate sealing the opening in the can; a first current collector plate positioned between the electrode assembly and the upper surface; a second current collector plate positioned between the electrode assembly and the cap plate; an insulator positioned between the upper surface and the first current collector plate; a terminal part inserted into the terminal hole of the upper surface; and a fixing member on the first current collector plate, the fixing member comprises a first fixing part and a second fixing part penetrating the first fixing part

The first fixing part is positioned between the insulator and the first current collector plate, and the second fixing part sequentially the upper surface, the insulator, and the first fixing part.

The first fixing part and the second fixing part comprises different materials.

The first fixing part comprises a metal, and the second fixing part comprises a resin.

The first fixing part and the first current collector plate comprise the same material.

The first fixing part is coupled to the terminal part and the first current collector plate.

The second fixing part is formed in a dot shape or a ring shape.

A distance between the second fixing part and the terminal part is 3.7 mm to 10 mm.

The first fixing part is positioned between the insulator and the first current collector plate, and the second fixing part penetrates the upper surface, the insulator, the first fixing part, and the first current collector plate.

A hole is formed in the first fixing part at a position corresponding to the terminal hole.

The terminal part comprises a protrusion inserted into the hole formed in the first fixing part.

The protrusion is in contact with the first current collector plate that is exposed through the hole in the first fixing part.

The protrusion is in contact with the first current collector plate exposed through the hole in the first fixing part, and the protrusion is in contact with the inner surface of the hole.

The first fixing part and the first current collector plate are formed integrally.

A size of the first fixed part is smaller than a size of the first current collector plate.

According to another embodiment, a secondary battery comprises a can comprising a side surface and an upper surface, with an opening being formed in the can, and with a terminal hole being formed in the upper surface; an electrode assembly accommodated in the can; a cap plate sealing the opening in the can; a first current collector plate positioned between the electrode assembly and the upper surface; a second current collector plate positioned between the electrode assembly and the cap plate; an insulator positioned between the upper surface and the first current collector plate; a terminal part inserted into the terminal hole of the upper surface; and a fixing member comprising a first fixing part and a second fixing part, with the second fixing part fixing the first fixing part to the upper surface and the first current collector plate.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view of a secondary battery according to an embodiment.

FIG. 2 is a cross-sectional view showing the A-A′ region of FIG. 1.

FIG. 3 is an enlarged view of the A region of FIG. 2.

FIGS. 4 and 5 are drawings showing the position of the fixing part.

FIGS. 6 and 7 are drawings showing the modification of the terminal part according to an embodiment and the comparative example.

FIGS. 8 to 10 are cross-sectional views of the A-A′ region of FIG. 1 according to another embodiment.

FIG. 11 is a perspective view of a battery module including secondary batteries according to some embodiments.

FIGS. 12 and 13 are perspective views of a battery pack including secondary batteries according to some embodiments.

FIGS. 14 and 15 is a perspective view and a side view of a vehicle including battery packs according to some embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, an electrode assembly and a secondary battery according to an embodiment will be described with reference to the drawings.

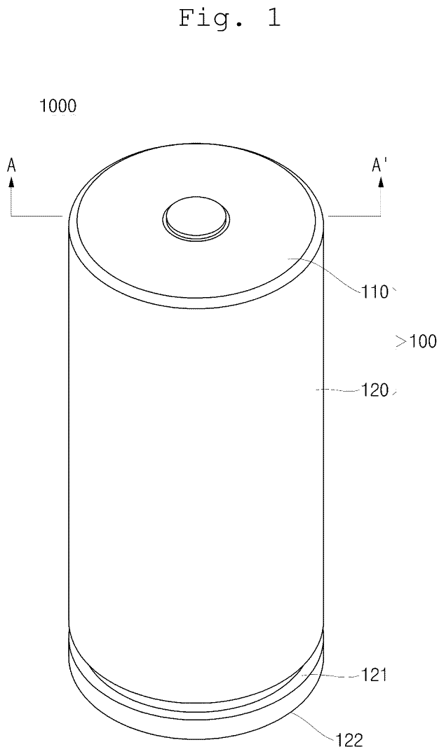

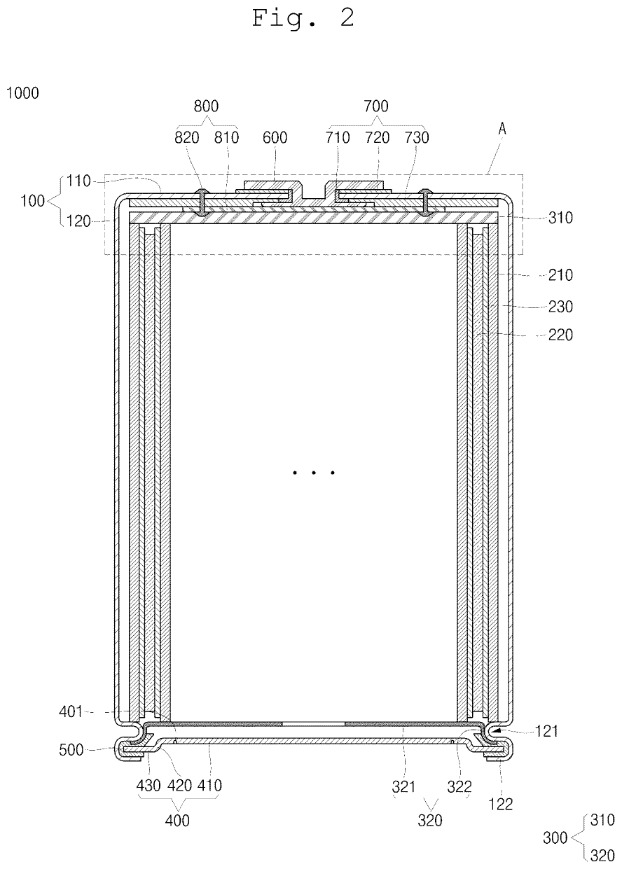

Referring to FIGS. 1 and 2, a secondary battery 1000 according to an embodiment may include a can 100, an electrode assembly 200, a current collector plate 300, a cap plate 400, a terminal part 600, and a fixing member 800.

The can 100 may be a case that accommodates the electrode assembly 200. The can 100 may be formed in a cylindrical shape.

The can 100 may include an upper surface 110 and a side surface 120. The upper surface 110 may be formed in a circular shape and may include a terminal hole disposed at the center of the upper surface 110.

The side surface 120 may be connected to the upper surface 110. For example, the side surface 120 and the upper surface 110 may be formed integrally. The upper surface 110 may be disposed on the side surface 120. The lower portion of the side surface 120 may be open such that the lower portion of the can 100 is open. Accordingly, the electrode assembly 200 may be inserted into the can 100 through the opening.

The side surface 120 may include a beading part 121 and a crimping part 122. The beading part 121 may be adjacent to the lower portion of the side surface 120, with the beading part 121 being formed concavely inward from the side surface 120. An end part spaced apart from the beading part 121 may be bent toward the inside of the can 100 to form a crimping part 122. The electrode assembly 200 is prevented from being moving to the outside of the can 100 by the beading part 121. The cap plate 400 may be disposed between the beading part 121 and the crimping part 122. The cap plate 400 may be fixed by the crimping part 122.

The can 100 may be formed from a conductive material. For example, the can 100 may be formed from steel, a steel alloy, aluminum, an aluminum alloy, or another alloy of these materials. The electrode assembly 200, the current collector plate 300, and the electrolyte may be accommodated in the can 100.

The electrode assembly 200 may include a first electrode 210 and a second electrode 220. A separator 230. The separator 230 may be disposed between the first electrode 210 and the second electrode 220. The electrode assembly 200 may be formed by winding the first electrode 210, the second electrode 220, and the separator 230 into a jelly roll shape.

The first electrode 210 includes a first current collector, with a first active material layer being provided on the first current collector. The first current collector includes a first surface and a second surface opposite the first surface. The first active material layer may be disposed on at least one of the first surface and the second surface of the first current collector. A first uncoated portion may be formed on the part(s) of the first and/or second surfaces of the first current collector where the first active material layer is not provided.

The second electrode 220 includes a second current collector and a second active material layer on the second current collector. The second current collector includes a first surface and a second surface opposite to the first surface. The second active material layer may be disposed on at least one of the first surface and the second surface of the second current collector. A second uncoated portion may be formed on the part(s) of the first and/or second surfaces of the second current collector where the second active material layer is not provided.

The first electrode 210 may be a positive electrode. In such a case, the first current collector may be formed from an aluminum foil and the first active material layer may include a transition metal oxide (LiCoO₂, LiNiO₂, LiMn₂O₄, etc.). The second electrode 220 may be a negative electrode. In such a case, the second current collector may be formed from copper foil or nickel foil and the second active material layer may include graphite or carbon.

The first uncoated portion and the second uncoated portion may be cut by notching. By the cutting, the first electrode 210 may be formed into a first substrate tab. And the second electrode 220 may be formed into a second substrate tab.

The separator 230 may function to prevent a short circuit between the first electrode 210 and the second electrode 220 while allowing the movement of lithium ions. The separator 230 may include a polyethylene film, a polypropylene film, or a polyethylene-polypropylene film.

The current collector plate 300 may be connected to the electrode assembly 200. The current collector plate 300 may include a first current collector plate 310 and a second current collector plate 320.

The first current collector plate 310 is disposed on the electrode assembly 200 between the upper surface 110 and the electrode assembly 200. The first current collector plate 310 may be circular shaped. The first collector plate 310 and the first current collector may be formed from the same material. For example, the first collector plate 310 may be formed from aluminum or an aluminum alloy. The first collector plate 310 may be smaller than the can 100. For example, the diameter of the first collector plate 310 may be smaller than the diameter of the can 100. Because the diameter of the first collector plate 310 is smaller than the diameter of the can 100, the first collector plate 310 may be disposed in the can but not contact the inner surface of the can 100.

The first collector plate 310 may be electrically connected to the first electrode 210. In particular, the first collector plate 310 may be connected to the first substrate tab, with the first substrate tab extending toward the first collector plate 310. After the first substrate tab is bent in one direction, the first collector plate 310 and the first substrate tab may be welded. And the first collector plate 310 may be electrically connected to the terminal part 600. In such cases, the first collector plate 310 may be directly or indirectly connected to the terminal part 600.

Therefore, the first electrode 210 and the terminal part 600 may be electrically connected by the first collector plate 310. Thus, the first current collecting plate 310 may form a passage for a current flow between the first electrode 210 and the terminal part 600.

The second collector plate 320 is disposed under the electrode assembly 200 between the cap plate 400 and the electrode assembly 200. The second collector plate 320 may be circular shaped. The second collector plate 320 and the second current collector may be formed from the same material. In an example, the second collector plate 320 may be formed from copper.

The second collector plate 320 may be electrically connected to the second electrode 220. In particular, the second collector plate 320 may be connected to the second substrate tab, with the second substrate tab extending toward the second current collector plate 320. After the second substrate tab is bent in one direction, the second current collector plate 320 and the second substrate tab may be welded. And the second current collector plate 320 may be electrically connected to the can 100.

The second current collector plate 320 may include a flat part 321 and a contact part 322. The flat part 321 may be a circular shaped. The contact part 322 may be an edge region of the second current collector plate 320. The flat part 321 may be welded to the second substrate tab. The contact part 322 may extend downward from an edge of the flat part 321 and may be in contact with the inner surface of the beading part 121. For this configuration, the contact part 322 may have a curvature corresponding to the curvature of the beading part 121. And the contact part 322 and the beading part 121 may be welded together. Accordingly, the second collector plate 320 and the can 100 may be electrically connected. However, the second collector plate 320 is not electrically connected to the cap plate 400. Therefore, the second electrode 220 and the can 100 may be electrically connected by the second collector plate 320. With this arrangement, the second current collecting plate 320 may form a passage for a current flow between the second electrode 220 and the can 100.

The terminal part 600 may be inserted into the terminal hole. A part of the terminal part 600 may be exposed to outside of the terminal hole. The terminal part 600 may be electrically connected to the first electrode 210 by the first current collector plate 310. And the terminal part 600 may be coupled to the upper surface 110 by a riveting method. That is, the terminal part 600 may be a rivet terminal.

The terminal part 600 may be inserted into the terminal hole from the outside toward the inside of the can 100. While the terminal part 600 is inserted into the terminal hole, the inner end of the terminal part 600 is compressed and deformed, for example, by pressing or spinning. Accordingly, the terminal part 600 may be firmly attached to the upper surface 110 of the can 100, with one end of the terminal part 600 positioned outside of the can 100 and the other end positioned inside of the can 100.

An insulator 700 may be disposed between the terminal part 600 and the can 100. The insulator 700 may prevent a short circuit between the terminal part 600 and the can 100. The insulator may include a first insulator 710, a second insulator 720, and a third insulator 730. The first insulator 710, the second insulator 720, and the third insulator 730 may be made from the same or different insulating materials.

The first insulator 710 may extend along the upper portion of the upper surface, the inside of the terminal hole, and along the lower portion of the upper surface. The first insulator 710 may have a circular plate shape including a hollow.

The second insulator 720 is disposed on the upper portion of the upper surface the upper surface 110 and the terminal part 600. In this arrangement, the second insulator 720 may surround the terminal hole.

The third insulator 730 is disposed on the lower portion of the upper surface between the upper surface and the first current collector 310. The third insulator 730 may be circular shaped and include an opening at its center.

The fixing member 800 may be disposed on the first current collector plate 310and may include a first fixing part 810 and a second fixing part 820. The fixing member 800 may be fixed to the can 100.and prevent separation of the terminal part. The fixing member will be described in detail below.

The cap plate 400 is disposed under the side surface 120 in the area of the opening of the can 100. Accordingly, the can 100 may be sealed by the cap plate 400. A gasket 500 may be disposed between the can 100 and the cap plate 400.

The cap plate 400 may include a plane part 410, an inclined surface 420 connected to the plane part 410, and an extended surface 430 extending from the inclined surface 420. The plane part 410 may be parallel to the second collector plate 320, and the inclined surface 420 may be inclined downward from an edge of the plane part 410. The extended surface 430 may extend from an edge of the inclined surface 420 and may extend parallel to the plane 410.

The extended surface 430 may be disposed between the beading part 121 and the crimping part 122 while being surrounded by the gasket 500. A notch 401 may be formed in the plane part 410. As such, the plane part 510 may be broken at the notch 401 when the pressure in the secondary battery 1000 becomes higher than the set pressure. Thus, gas in the secondary battery 1000 may be discharged by the breaking at the notch 401. Thus, in other words, the notch 401 with a thinner thickness than other parts is formed in the cap plate forms a vent.

The gasket 500 may be disposed between the lower portion of the beading part 121 and the crimping part 122. The gasket 500 may surround the extension surface 430. The gasket 500 may surround part or all of the extension surface 430. A side in which the gasket 500 and the extension surface 430 are in contact may be defined inward. A side in which the gasket 500 is in contact with the beading part 121 may be defined outward.

A part of the contact part 322 of the second current collector plate 320 may be inserted between the outer upper part of the gasket 500 and the beading part 121. The gasket 500 is therefore prevents the contact part 322 and the extension surface 430 from contacting each other. That is, the gasket 500 may insulate the cap plate 400 and the can 100, and the gasket 500 may insulate the cap plate 400 and the second current collector plate 320.

With the configuration of the secondary battery as described above, the terminal part 600 may be a positive electrode, and the can 100 may be a negative electrode.

When the secondary battery is exposed to a high temperature environment, the electrolyte disposed in the can may be vaporized. Accordingly, gas may be generated in the can, and the internal pressure and internal temperature of the can may increase. But, as described above, a notch in the cap plate may break at the set internal pressure. Accordingly, the gas may be discharged to outside of the can.

The internal pressure of the can is also transmitted to the upper portion of the secondary battery. Accordingly, the terminal part may be separated as the upper portion of the can is lifted by the increased pressure. In such a case, the terminal hole between the terminal part and the upper surface may be partially exposed. And the gas may leak through the exposed terminal hole. The leaking gas through the upper side may affect the breaking pressure of the cap plate while the internal pressure of the can is reduced. That is, the cap plate may not break because the set pressure may not be reached. As a result, a fire in the secondary battery may occur.

Embodiments of the present disclosure may solve the problem of the gas leaking through the upper side of secondary battery by the provision of the fixing member. Hereinafter, the fixing member will be described in detail with reference to the drawings.

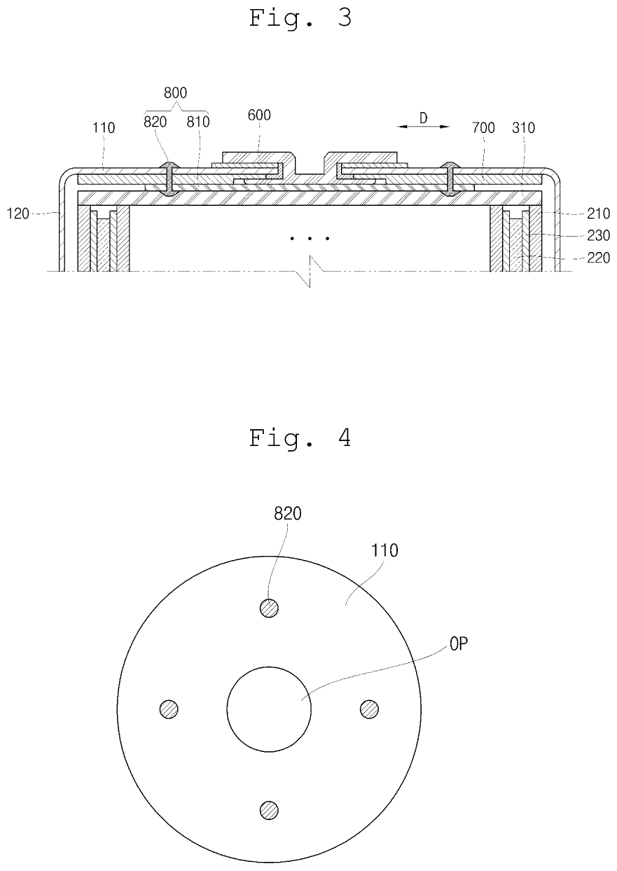

Referring to FIGS. 2 to 7, the fixing member 800 may include a first fixing part 810 and a second fixing part 820.

The first fixing part 810 may be positioned between the upper surface 110 and the first current collector plate 310. In particular, the first fixing part 810 may be positioned between the insulator 700 and the first current collector plate 310, and the first fixing part 810 may be positioned between the terminal part 600 and the first current collector plate 310.

The first fixing part 810 may be a circular shaped plate positioned on the first current collector plate 310. The first fixing part 810 may be smaller than the first current collector plate 310. For example, the width and/or thickness of the first fixing part 810 may be smaller than the width and/or thickness of the first current collector plate.

The second fixing part 820 may include at least one fixing part that is coupled to the first fixing part 810. The second fixing part 820 may penetrate the first fixing part 810. More specifically, the second fixing part 820 may penetrate the upper surface 110, the insulator 700, and the first fixing part 810.

In an example, the second fixing part 820 may have a “T” shape that sequentially penetrates the upper surface 110, the insulator 700, and the first fixing part 810. Then, the lower and upper parts of the second fixing part 820 may be pressed and formed using a jig. As a result, the second fixing part 820 may penetrate and be coupled to the upper surface 110, the insulator 700, and the first fixing part 810.

The first fixing part 810 and the second fixing part 820 be formed from different materials. The first fixing part 810 may include a conductive material. For example, the first fixing part 810 may include a metal such as the same or different metal as the first current collector plate 310. In specific examples, the first fixing part 810 may be formed from aluminum or stainless steel. The second fixing part 820 may be formed from a non-conductive material. For example, the second fixing part 820 may be formed from a resin, and the second fixing part 820 may include polypropylene or polyethylene terephthalate.

The first fixing part 810 may be connected to the terminal part 600. For example, the first fixing part 810 may be coupled to the terminal part 600 by welding. The first fixing part 810 also may be connected to the first current collector plate 310. For example, the first fixing part 810 may be coupled to the first current collector plate 310 by welding. With such a configuration, the first electrode 210 may be electrically connected to the terminal part 600 by the first current collector plate 310 and the first fixing part 810.

The first fixing part 810 may be insulated from the can 100 by the insulator 700 being disposed between the first fixing part 810 and the upper surface 110.

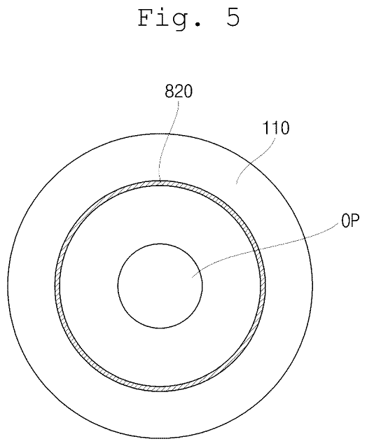

The second fixing part 820 may be formed in various shapes. Referring to FIG. 4, the second fixing part 820 may be formed to a dot shape when viewed from above. The second fixing part 820 may include a plurality of fixing parts spaced apart from each other. Referring to FIG. 5, in another embodiment the second fixing part 820 may have a loop shape. That is, the second fixing part 820 may be formed as a ring shape along the outer diameter of the upper surface.

The second fixing part 820 may be disposed at a set position. In detail, the second fixing part 820 may be spaced apart from the terminal part 600 by a set distance D. In some embodiments, the distance D between the second fixing part 820 and the terminal part 600 may be 3.7 mm or more. More specifically, the distance D between the second fixing part 820 and the terminal part 600 may be 3.7 mm to 10 mm. When the distance D between the second fixing part 820 and the terminal part 600 is less than 3.7 mm, the gap between the second fixing part 820 and the terminal part 600 is reduce. As a result, the terminal part 600 may be damaged during the process of forming the second fixing part 820. When the distance D between the second fixing part 820 and the terminal part 600 exceeds 10 mm, the gap between the second fixing part 820 and the terminal part 600 is increased. In such a case, the first fixing part 810 is not sufficiently fixed by the second fixing part 820, and the deformation of the first fixing part 810 may be increased.

With embodiments of the present disclosure, the fixing member may prevent the formation of a gap in the terminal hole.

Referring to FIG. 6, gas generated in the secondary battery may cause the internal pressure to increase. The upper surface 110 may be lifted upward by the pressure. For example, the upper surface 110 may be deformed at a first angle θ1 of 5° or more. Accordingly, a gap G may be formed between the terminal part 600 and the insulator 700. Also, a crack may be formed in the terminal part 600 to form the gap (G). Accordingly, the internal gas may be discharged to outside through the gap. Accordingly, the internal pressure of the can may be lowered. As a result, the set pressure may not be reached to break the cap plate. As a result, the internal temperature of the can increases, and a fire in the secondary battery may occur.

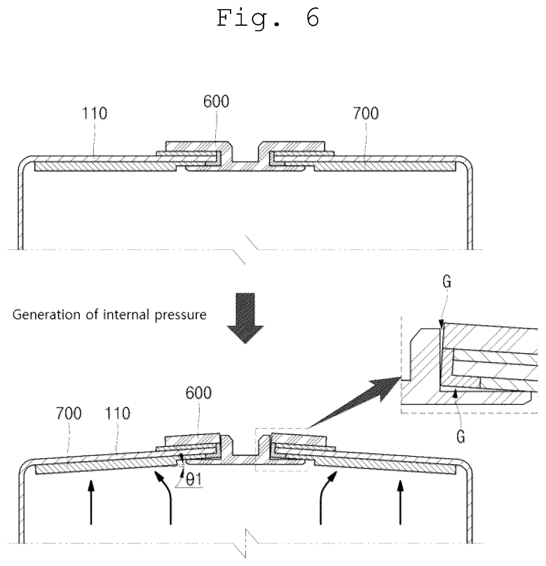

Referring to FIG. 7, the deformation of the upper surface 110 may be reduced by the fixing member 800. In particular, the deformation of the top surface 110 and the terminal part 800 may be reduced by the fixing member 800. For example, the top surface 110 may be deformed at a second angle θ2 that is 2° or less. Accordingly, no gap G is opened between the terminal part 600 and the insulator 700. Or, if the gap does open, the size of the gap G is reduced. Further, cracks in the terminal part 600 may be prevented. Accordingly, the inside of the secondary may reach the set pressure where the notch is broken, and a fire in the secondary battery may be prevented.

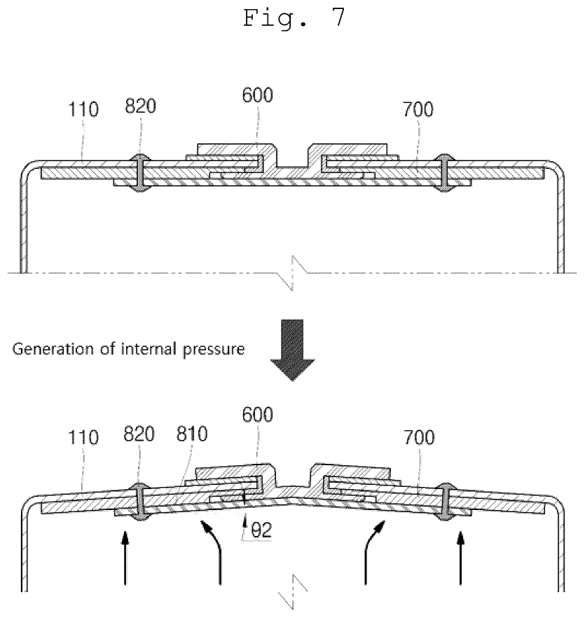

Hereinafter, another embodiment will be described with reference to FIGS. 8 to 10. Features that are the same as in the embodiments described above will be omitted, and the same drawing reference numerals are given to the same configurations as those in the embodiments described above.

Referring to FIG. 8, in further embodiments of the present disclosure the first current collector plate 310 or the first fixing part 810 may be omitted. In the example depicted in FIG. 8, the first current collecting plate 310 is omitted. The first fixing part 810 may be formed from the same or similar material as the first uncoated portion. For example, the first fixing part 810 may include aluminum.

The first fixing part 810 may be coupled to the first uncoated portion by welding. Accordingly, the terminal part 600 may be electrically connected to the first electrode 210 by the first fixing part 810.

In other embodiments, the first fixing part 810 may be omitted. In such embodiments, the first current collector plate 310 may be coupled to the first uncoated portion by welding. Accordingly, the terminal part 600 may be electrically connected to the first electrode 210 by the current first collector plate 310.

As shown in FIG. 9, the second fixing part 820 may penetrate the first current collector plate 310. In detail, the second fixing part 820 may sequentially penetrate the upper surface 110, the insulator 700, and the first current collector plate 310. Thus, the second fixing part 820 may be coupled to the can 100, the insulator 700, and the first current collector plate 310.

As described above, the first fixing part may be the first current collector plate, or the first current collector plate may be the first fixing part. As such, the first fixing part and the first current collector plate may be formed integrally. Or, in other words, either the first fixing part or the first current collector plate may be omitted. Thus, the size of the electrode assembly may be increased by the thickness corresponding to the omitted first fixing part or the first current collector plate. The secondary battery may thereby have improved electric capacity.

Referring to FIG. 9, a hole may be formed in the first fixing part 810. The hole of the first fixing part may correspond to the terminal hole of the upper surface. In such an arrangement, the first current collector plate may be exposed to outside by the holes.

The terminal part 600 may include a protrusion. The protrusion is inserted into the hole of the first fixing part such that the protrusion contacts the first current collector plate 310. In detail, the protrusion and the first current collector plate 310 may be coupled to the first current collector plate 310 by welding. The size of the hole may be larger than the size of the protrusion, with the protrusion thereby contacting the first current collector plate. In other embodiments, the size of the hole may be the same as or similar to the size of the protrusion, with the protrusion thereby contacting the inner surface of the hole and the first current collector plate.

Thus, the terminal part 600 may be electrically connected to the first electrode 210 by the first current collector plate 310. The current from the first electrode 210 directly moves to the terminal part 600 by way of the first current collector plate 310. Therefore, the resistance of the current may be reduced compared to the case where the current flows through the fixed member. Also, a coupling area of the terminal part 600 can be increased by the protrusion. Accordingly, the deformation of the terminal part 600 due to pressure may be reduced.

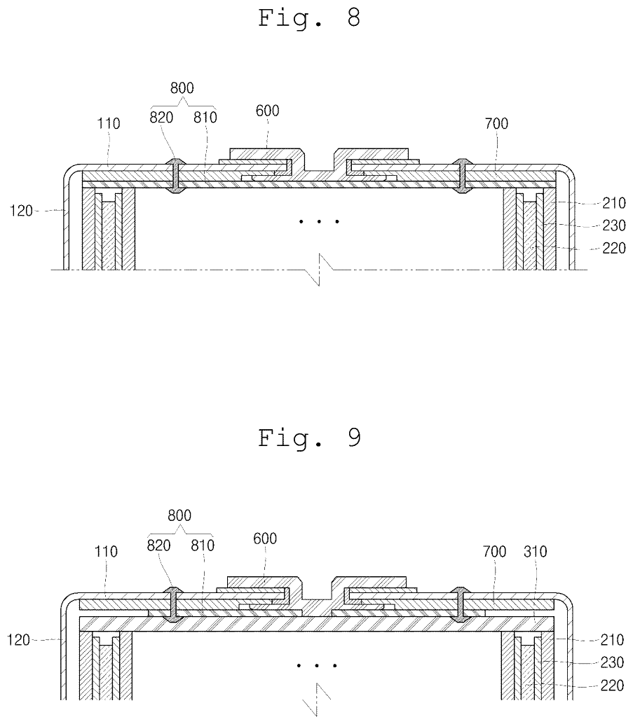

Referring to FIG. 10, the second fixed part 820 may penetrate through the first current collector plate 310. In detail, the second fixed part 820 may sequentially penetrate the upper surface 110, the insulator 700, the first fixed part 810, and the first current collector plate 310. Accordingly, the first current collector plate 310 may play the role of the first fixed part and deformation of the terminal part due to internal pressure may be reduced.

According to embodiments of the present disclosure, adhesion between the first current collector plate 310 and the first fixing part 810 may be improved. When the second fixing part 820 penetrates only the first fixing part 810, the adhesion between the first current collector plate 310 and the first fixing part 810 may be reduced by the second fixing part 820. For example, as the size of the second fixing part protruding outward from the first fixing part 810 increases, the adhesion between the first current collector plate 310 and the first fixing part 810 may be reduced. But when the second fixing part 820 penetrates the first current collector plate 310, protruding of the second fixing part between the first current collector plate 310 and the first fixing part 810 is avoided. Therefore, separation of the first current collector plate 310 and the first fixing part 810 may be prevented.

The secondary battery according to embodiments of the present disclosure includes the fixing member. The fixing member includes the first fixing part and the second fixing part. The first fixing part is disposed on the first current collector plate or the first fixing member may replace the first current collector plate. The second fixing part penetrates the first fixing part. More specifically, the second fixing part penetrates the upper surface of the can, the insulator, and the first fixing part. Accordingly, the second fixing part is coupled to the can, the insulator, and the first fixing part.

When the secondary battery is exposed to a high temperature, gas is generated by vaporization of the electrolyte in the can. Accordingly, the internal pressure of the can increases. The pressure is transmitted to the upper and lower portions of the can. When the pressure moves upward, the upper surface of the can is lifted upward, and the terminal part may be deformed. The gap may be formed between the terminal part and the insulator and/or a crack may be formed in the terminal part. Accordingly, the gas may leak through the gap. Thus, the secondary battery may not reach a pressure that breaks open the vent of the secondary battery.

But in embodiments of the present disclosure, the fixing member prevents the deformation of the terminal part. Accordingly, the gap is not formed by the deformation of the terminal part. And the vent is broken when the internal pressure of the secondary battery reaches a certain point. Accordingly, a fire of the secondary battery due caused by a delay in the vent breaking may be prevented.

The secondary battery may be used in portable small electronic devices such as smartphones, feature phones, notebook computers, digital cameras, and camcorders. A battery module and a battery pack including a plurality of secondary batteries may be used as a power source for driving a motor of a hybrid vehicle or an electric vehicle and as a battery for storing power.

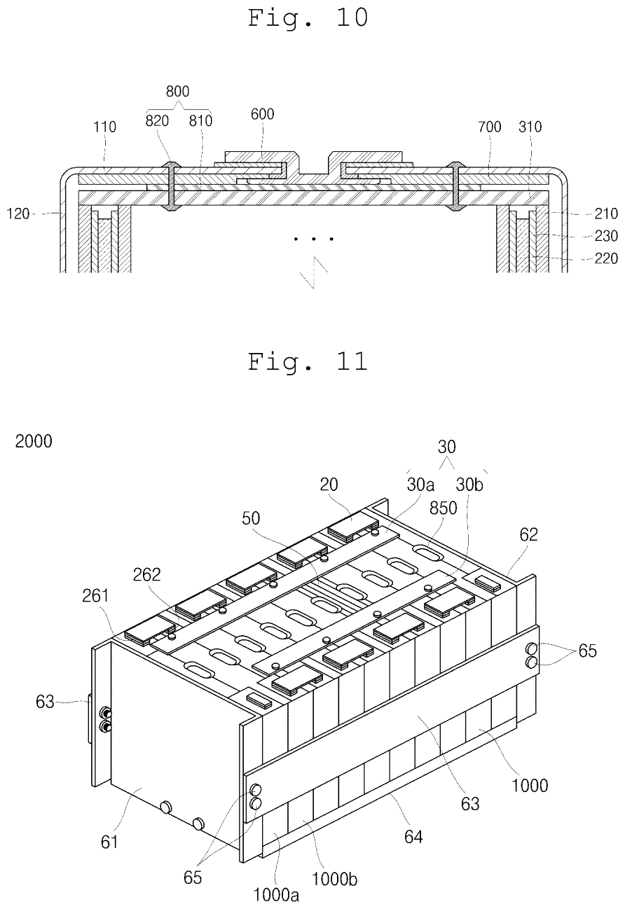

Hereinafter, the battery module including secondary batteries according to embodiments will be described with reference to FIG. 11.

Referring to FIG. 11, the battery module 2000 according to one or more example embodiments of the present disclosure includes terminal parts 261 and 262, a plurality of secondary battery 1000 arranged in one direction, a connection tab 20 connecting a secondary battery 1000a to an adjacent secondary battery 1000b, and a protection circuit module 30 having one end connected to the connection tab 20. The protection circuit module 30 may include a battery management system (BMS). Further, the connection tab 20 may include a body portion in contact with the terminal parts 261 and 262 between the adjacent secondary battery 1000a and 1000b and an extension portion extending from the body portion and connected to the protection circuit module 30. The connection tab 20 may be, for example, a bus bar.

Each secondary battery 1000 may include a battery case, an electrode assembly received (or accommodated) in the battery case, and an electrolyte. The electrode assembly and the electrolyte react electrochemically to store and release (e.g., generate) energy. Terminal parts 261 and 262 electrically connected to the connection tab 20 and a vent 850 as a discharge passage for gas generated inside the battery case may be provided on one side of (e.g., an upper side of) the secondary battery 1000. The terminal parts 261 and 262 of the secondary battery 1000 may be a positive electrode terminal 261 and a negative electrode terminal 262 having different polarities from each other, and the terminal parts 261 and 262 of the adjacent secondary battery 1000a and 1000b may be electrically connected to each other in series or parallel by the connection tab 20, to be described in more detail below. Although a serial connection has been described as an example, the connection structure is not limited thereto, and various connection structures may be employed as desired or necessary. In addition, the number and arrangement of secondary battery is not limited to the structure shown in FIG. 10 and may be changed as desired or necessary.

The plurality of secondary batteries 1000 may be arranged in (e.g., may be stacked in) one direction so that the wide surfaces of the secondary batteries 1000 face each other, and the plurality of secondary batteries 1000 may be fixed by the housings 61, 62, 63, and 64. The housings 61, 62, 63, and 64 may include a pair of end plates 61 and 62 facing the wide surfaces of the secondary battery batteries 1000 and a side plate 63 and a bottom plate 64 connecting the pair of end plates 61 and 62 to each other. The side plate 63 may support side surfaces of the secondary batteries 1000, and the bottom plate 64 may support bottom surfaces of the secondary batteries 1000. In addition, the pair of end plates 61 and 62, the side plate 63 and the bottom plate 64 may be connected by bolts 65 and/or any other suitable fastening members and methods known to those of ordinary skill in the art.

The protection circuit module 30 may have electronic components and protection circuits mounted thereon and may be electrically connected to connection tabs 20, to be described in more detail later. The protection circuit module 30 includes a first protection circuit module 30a and a second protection circuit module 30b extending along the direction in which the plurality of secondary batteries 1000 are arranged in different locations. The first protection circuit module 30a and the second protection circuit module 30b may be spaced from each other at a suitable or desired interval (e.g., a predetermined interval) and arranged parallel to each other to be electrically connected to adjacent connection tabs 20, respectively. For example, the first protection circuit module 30a extends on one side of the upper portion of the plurality of secondary batteries 1000 along the direction in which the plurality of secondary batteries 1000 are arranged, and the second protection circuit module 30b extends to the other upper side of the plurality of secondary batteries 1000 along the direction in which the plurality of secondary batteries 1000 are arranged. The second protection circuit module 30b may be spaced from the first protection circuit module 30a at a suitable or desired interval (e.g., a predetermined interval) with the vents 850 interposed therebetween but may be disposed parallel to the first protection circuit module 30a. As such, the two protection circuit modules are spaced from each other side-by-side along the direction in which the plurality of secondary batteries 1000 are arranged, thereby reducing or minimizing the area of the printed circuit board (PCB) constituting the protection circuit module. By separately configuring the protection circuit module into two protection circuit modules, unnecessary PCB area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding and/or any other suitable connection methods known to those of ordinary skill in the art.

In addition, the connection member 50 may be or include, for example, an electric wire. In addition, the connection member 50 may be made of or include a material having elasticity or flexibility. By the connecting member 50, it may be possible to check and manage whether the voltage, temperature, and/or current of the plurality of secondary battery 1000 are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 1000 swells, shocks may be absorbed by the elasticity or flexibility of the connection member 50, thereby hindering or preventing the first and second protection circuit modules 30a and 30b from being damaged.

In addition, the shape and structure of the connection member 50 is not limited to the shape and structure shown in FIG. 11.

As described above, because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The secondary battery and battery modules according to the previously described example embodiments may be used to manufacture the battery pack.

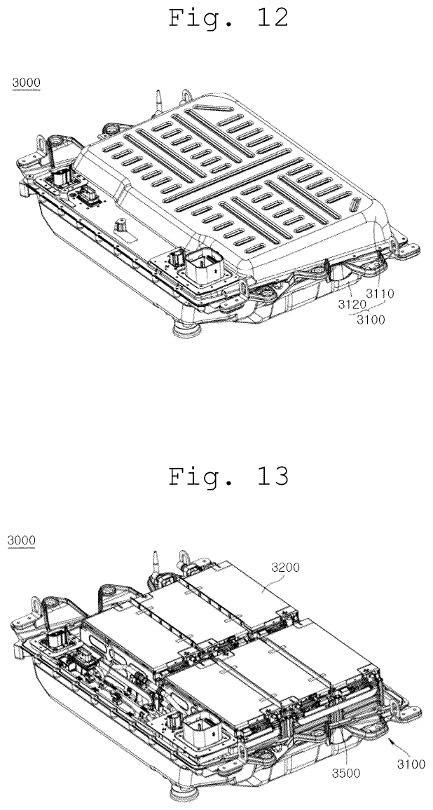

FIGS. 12 and 13 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

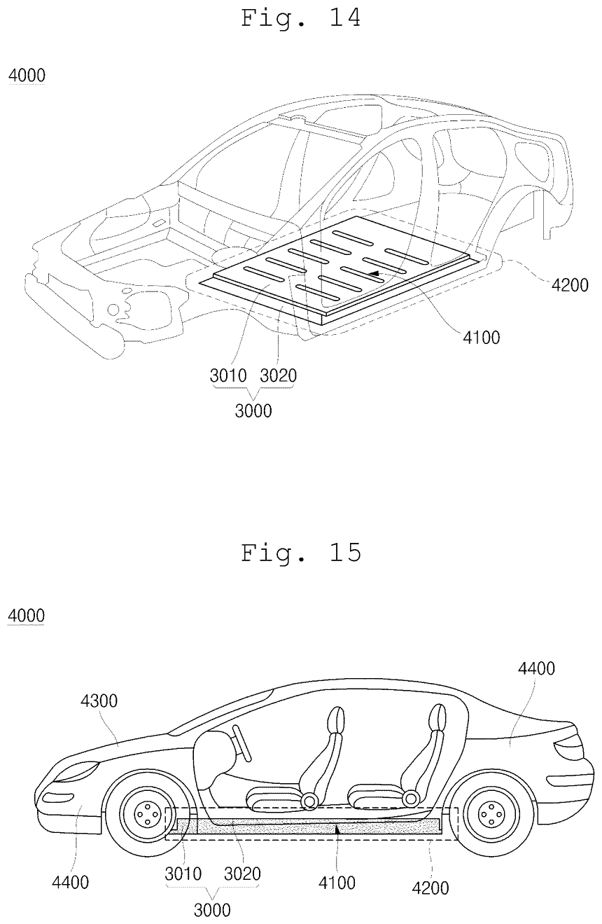

In FIG. 14, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

In FIG. 15, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. A secondary battery comprising:
a can comprising a side surface and an upper surface, with an opening being formed in the can, and with a terminal hole being formed in the upper surface;
an electrode assembly accommodated in the can;
a cap plate sealing the opening in the can;
a first current collector plate positioned between the electrode assembly and the upper surface;
a second current collector plate positioned between the electrode assembly and the cap plate;
an insulator positioned between the upper surface and the first current collector plate;
a terminal part inserted into the terminal hole of the upper surface; and
a fixing member on the first current collector plate,
wherein the fixing member comprises a first fixing part and a second fixing part penetrating the first fixing part.

2. The secondary battery as claimed in claim 1, wherein the first fixing part is positioned between the insulator and the first current collector plate, and
wherein the second fixing part penetrates the upper surface, the insulator, and the first fixing part.

3. The secondary battery as claimed in claim 2, wherein the first fixing part and the second fixing part comprises different materials.

4. The secondary battery as claimed in claim 3, wherein the first fixing part comprises a metal, and
wherein the second fixing part comprises a resin.

5. The secondary battery as claimed in claim 4, wherein the first fixing part and the first current collector plate comprise a same material.

6. The secondary battery as claimed in claim 2, wherein the first fixing part is coupled to the terminal part and the first current collector plate.

7. The secondary battery as claimed in claim 2, wherein, as viewed from above, the second fixing part is formed in a dot shape or a ring shape.

8. The secondary battery as claimed in claim 2, wherein a distance between the second fixing part and the terminal part is 3.7 mm to 10 mm.

9. The secondary battery as claimed in claim 1, wherein the first fixing part is positioned between the insulator and the first current collector plate, and
wherein the second fixing part penetrates the upper surface, the insulator, the first fixing part, and the first current collector plate.

10. The secondary battery as claimed in claim 1, wherein a hole is formed in the first fixing part at a position corresponding to the terminal hole.

11. The secondary battery as claimed in claim 10, wherein the terminal part comprises a protrusion inserted into the hole formed in the first fixing part.

12. The secondary battery as claimed in claim 11, wherein the protrusion is in contact with the first current collector plate that is exposed through the hole in the first fixing part.

13. The secondary battery as claimed in claim 11, wherein the protrusion is in contact with the first current collector plate exposed through the hole in the first fixing part, and the protrusion is in contact with the inner surface of the hole.

14. The secondary battery as claimed in claim 1, wherein the first fixing part and the first current collector plate are formed integrally.

15. The secondary battery as claimed in claim 1, wherein a size of the first fixed part is smaller than a size of the first current collector plate.

16. A secondary battery comprising:
a can comprising a side surface and an upper surface, with an opening being formed in the can, and with a terminal hole being formed in the upper surface;
an electrode assembly accommodated in the can;
a cap plate sealing the opening in the can;
a first current collector plate positioned between the electrode assembly and the upper surface;
a second current collector plate positioned between the electrode assembly and the cap plate;
an insulator positioned between the upper surface and the first current collector plate;
a terminal part inserted into the terminal hole of the upper surface; and
a fixing member comprising a first fixing part and a second fixing part, with the second fixing part fixing the first fixing part to the upper surface and the first current collector plate.
